(19) United States
(12) Patent Application Publication
(10) Pub. No.: US 2025/0147475 A1
(43) Pub. Date: May 8, 2025

(54) METHOD AND DEVICE FOR ASSESSING THE QUALITY OF AN OPTIMIZATION-BASED CONTROL SIGNAL PRIOR TO ITS USE IN A TECHNICAL SYSTEM

(71) Applicant: Volvo Truck Corporation, Göteborg (SE)

(72) Inventors: Esteban Gelso, Västra Frölunda (SE); Leo Laine, Göteborg (SE)

(21) Appl. No.: 18/838,003

(22) PCT Filed: Feb. 21, 2022
(86) PCT No.: PCT/EP2022/054259

§ 371 Date: Aug. 13, 2024

(51) Int. Cl. G05B 13/04

(52) U.S. Cl. CPC G05B 13/042

(57) ABSTRACT

A method for assessing the quality of a solution from an optimization process configured to solve a constrained quadratic problem (QP), the method comprising: initiating an execution of an active-set optimization process configured to solve the constrained QP; obtaining a first solution vector and an associated active set of constraints from the execution of the active-set optimization process; substituting variables in the constrained QP in accordance with the active set of constraints to form an associated unconstrained QP; initiating an execution of a second optimization process configured to solve the associated unconstrained QP; obtaining a second solution vector from the execution of the second optimization process; and generating a quality indicator for the first solution vector on the basis of a difference between the first and the second solution vectors.

### TECHNICAL FIELD

The present disclosure relates to the field of optimization-assisted automatic control technology. In particular, it proposes a method for assessing the quality of a solution from an optimization process configured to solve a constrained quadratic problem. The method can be applied to the control allocation problem in an electric vehicle, which is typically an underdetermined problem.

### BACKGROUND

In vehicles like battery-electric vehicles or fuel-cell vehicles, several actuators in the powertrain are available to perform a required motion. The powertrain is normally an over-actuated system (more controlled inputs than outputs), so that its control represents an under-determined problem (fewer equations than unknowns), and a coordination of the actuators for motion is required. This coordination can be referred to as control allocation. It would be desirable to use optimization-assisted automatic control techniques, and more precisely to treat and solve the control allocation problem as an optimal control problem (OCP). While the processing power sufficient to repeatedly solve the evolving OCP at runtime can normally be ensured today, the usefulness of optimization techniques is still restrained by the fact that numerical optimization solvers incidentally produce erroneous outputs due to convergence problems, artefacts, instabilities and the like. Inaccuracies are relatively more frequent in OCPs that are ill-conditioned. The severity of this characteristic can be quantified in terms of an absolute or relative condition number; the condition number may be said to represent the maximum rate of change, which can be estimated by differentiating the OCP and maximizing of the absolute value. The condition number generally reflects how rounding errors propagate and amplify in floating-point arithmetic operations. Reliably judging whether an optimizer output is correct before it is applied as control signal can a be challenging task in the absence of reference knowledge, such as the output of a redundant optimizer, and especially under time pressure which is the rule in real-time systems.

Specifically, in order to comply with a required Automotive Safety Integrity Level (ASIL), the potential hazards caused by malfunctioning electrical or electronic systems should be eliminated or reduced. When optimization processes based on iterative methods are used in critical control strategies, there is always a concern that the optimizers will not be able to compute a good solution in the scheduled time in an electronic control unit (ECU) of the vehicle. If the temporary drop in solution quality goes unnoticed and a sub-optimal solution is used unawares—without taking suitable safety measures—the energy consumption, mechanical wear, ride comfort and drivability could be negatively affected.

### SUMMARY

One objective of the present disclosure is to make available a method by which the quality of a solution from an optimization process configured to solve a constrained quadratic problem (QP) can be assessed. An intended use of the method is when the constrained QP relates to control of a technical system, wherein the aimed-for method can support a decision whether or not the solution should be utilized for generating a control signal to the technical system. It is of particular interest to enable real-time control of the technical system, such as a propulsion system in an electric vehicle, especially in a battery-electric vehicle. A further objective of the present disclosure is to make available a quality assessment method that does not require having an independent optimization process duplicate the solving of the constrained QP. A still further objective is to provide a device and computer program with these abilities.

At least some of these objectives are achieved by the invention as defined by the independent claims. The dependent claims relate to advantageous embodiments of the invention.

In a first aspect of the present disclosure, there is provided a method for assessing the quality of a solution from an optimization process configured to solve a constrained QP, the method comprising: initiating an execution of an active-set (AS) optimization process configured to solve said constrained QP; obtaining a first solution vector u* and an associated active set of constraints S* from the execution of the AS optimization process; substituting variables in the constrained QP in accordance with the active set of constraints S* to form an associated unconstrained QP; initiating an execution of a second optimization process configured to solve the associated unconstrained QP; obtaining a second solution vector u** from the execution of the second optimization process; and generating a quality indicator q for the first solution vector u* on the basis of a difference between the first and second solution vectors. The difference can be related to a vector difference u*−u** of the first and second solution vectors, such as a norm of a vector difference ∥u*−u**∥, or to a difference in cost, as measured by a cost functional J(u) to which the QP relates.

The inventors have realized that the associated unconstrained QP, which is formed on the basis of the constrained QP in the above-described manner, normally produces a solution close to the solution of the constrained QP. If the AS optimization process produces an incorrect solution to the constrained QP, it is very unlikely that the second optimization process is affected by an identical error when solving the unconstrained QP. For these reasons, the difference between the respective solution vectors of these two QPs is a useful indirect indicator as to whether the first solution vector u* is a correct solution of the unconstrained QP. In other words, the difference can be used to recognize unreliable solutions and stop these from influencing control signals to technical systems.

Although the proposed consideration of the difference is merely an indirect indication, it is much simpler in practical cases than trying to establish the degree of reliability first solution vector u* by directly evaluating the past execution of the AS optimization process, e.g., by inspecting internal variables. Moreover, the proposed quality assessment method does not require re-solving the constrained QP (or redundantly solving it in parallel) but can be executed at the cost of merely solving the associated unconstrained QP. This can generally be realized at significantly lower computational cost.

A further observation made in the course of the development and verification the present invention is that, for a wide range of optimization problems, the error of the associated unconstrained QP is substantially unaffected by variations in the constrained QP's condition number. In other words, the second solution vector u** stays a reliable reference even when the constrained QP grows increasingly ill-conditioned. In terms of dynamical system theory, it may be hypothesized that a correct first solution vector u* acts as a strong attractor, so that convergence can be expected for the unconstrained QP as well.

In some embodiments, wherein the predefined constrained QP includes an optimization of a cost functional J, the quality indicator can be defined in such manner that it depends not only on the difference ∥u*−u**∥ but also on a difference in cost for these solution vectors, such as |J(u*)−J(u**)|.

Further embodiments particularly address iterative optimization processes, where insufficient convergence is a potential error source. This is inherent in real-time control of technical systems, wherein the optimization process typically has to produce a useful solution in the interval between two control signal updates. The AS optimization process or the second optimization process, or both, may be iterative. To meet the real-time control target, the solution vectors u*, u** are extracted from the respective optimization processes after a suitably chosen delay.

In still further embodiments, wherein the constrained QP relates to control of a technical system, the quality indicator is used as basis for a decision whether to utilize the first solution vector u* for generating a control signal u to the technical system. By making the execution first solution vector u* conditional on the quality indicator, a robust safeguard against damage to persons and machinery can be established. In further developments, another possible outcome of the decision may be to utilize the second solution vector u** for generating the control signal u to the technical system.

In one embodiment, the technical system to be controlled is a propulsion system (or powertrain, or drivetrain) in a road vehicle. The controlled inputs include inputs to a plurality of electric drives, which may have different gear ratios and/or different acceleration/regeneration power limits. In the present disclosure, the term “road vehicle” shall include cars, buses, long-haul trucks, as well as light and heavy construction equipment and all-terrain vehicles. The term excludes rail vehicles and various types of suspended vehicles.

In a second aspect of the invention, there is provided a controller configured to control a technical system in real time. The controller may be implemented as a general-purpose computer executing suitable software. For example, it may comprise memory, a signal interface and processing circuitry configured to perform the method of the first aspect of the invention. The second aspect of the invention generally shares the effects and advantages of the first aspect, and it can be embodied with a corresponding degree of technical variation.

The invention further relates to a computer program containing instructions for causing a computer, or the controller in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

### BRIEF DESCRIPTION OF THE DRAWINGS

Aspects and embodiments are now described, by way of example, with reference to the accompanying drawings, on which:

FIG. 1A shows, in block-diagram form, a controller configured to produce a control signal u to be applied to a technical system which causes the system to approach a received setpoint signal r;

FIG. 1B illustrates example information flows and computations within the controller;

FIG. 2 is a flowchart of a method according to embodiments herein;

FIG. 3 shows a road vehicle;

FIG. 4 plots, as a function of the constrained QP's condition number, the error of an optimization process solving the constrained QP relative to a ground-truth solution of the constrained QP;

FIG. 5 plots, as a function of the constrained QP's condition number, the error of an optimization process solving the associated unconstrained QP relative to a ground-truth solution of the constrained QP;

FIG. 6 is a plot of the difference ∥u*−u**∥ between the first and second solution vectors for a constrained QP modelling a propulsion system in a road vehicle.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

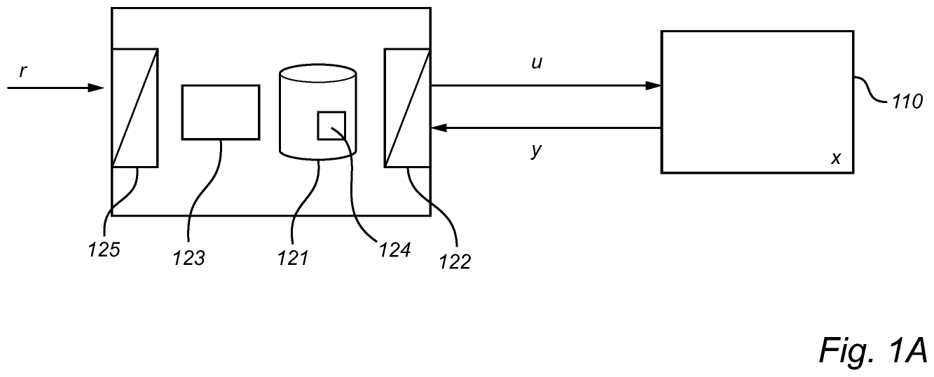

FIG. 1A is a block diagram depicting a technical system 110 associated with a controller 120. The controller 120 is configured to produce a control signal u to be applied to the technical system 110 on the basis of a setpoint signal r (or reference signal) and an observation signal y. The technical system 110 can be modeled mathematically, e.g., as a time-invariant linear dynamical system, time-invariant nonlinear dynamical system or a time-dependent dynamical system. The time evolution of a linear dynamical system with a state vector x may be governed by the following equations:

$$\{ \begin{matrix}{x}^{′} ( t ) & = Ax ( t ) + Bu ( t ) \\ y ( t ) & = Cx ( t ) + Du ( t )\end{matrix}$$

where A, B, C, D are constant matrices, which are constant with respect to time if the system is time-invariant. A nonlinear system model may have the following appearance:

$$\{ \begin{matrix}{x}^{′} ( t ) = f ( x ( t ) , u ( t ) , t ) \\ y ( t ) = g ( x ( t ) , u ( t ) , t )\end{matrix}$$

Here, the time dependence of functions ƒ, g is absent if the modeled nonlinear dynamical system is time-invariant.

An overreaching purpose of the controller 120 is to provide a control signal u which causes the system 110 to evolve in such manner that the setpoint signal r is achieved or approximately achieved. Accordingly, the controller 120 realizes a mapping from r to u, which mapping may have a dependence on past and/or current values of y. The setpoint signal r can be provided by an operator, an executing software process, a networked computer; in the particular case of a vehicle, it may be provided by the driver. The setpoint signal r can be expressed as a value of the observation signal, in which case it is achieved when r(t)=y(t). Alternatively, the setpoint signal r can be expressed in terms of one of the state variables of the system (i.e., as one of the components of x) or a combination of these which is of relevance to the person or device which provides the setpoint signal r. The task of generating a control signal u by which the technical system 110 achieves the setpoint signal r in time |t₀−t_{ƒ}| in the most economical manner may be referred to as an optimal control problem. It may be formulated, in discrete or continuous time, as the minimization of a cost functional J subject to the system dynamics and various further constraints C1, C2, . . . :

$${min}_{u} J ( x ( \cdot ) , u ( \cdot ) , {t}_{0} , {t}_{f} )$$

$$s . t . {x}^{′} ( t ) = Ax ( t ) + Bu ( t )$$

$$C 1 , C 2 , …$$

The minimization is performed over the set of admissible solution vectors of the form u=[u(t₀) u(t₀+Δt) u(t₀+2Δt) . . . u(t_{ƒ})], where Δt denotes a time step and each component u(t₀+nΔt), n∈ [symbol] , can be either a scalar or a vector of scalars. A continuous-time representation of the solution vector may be u={u(t):t₀≤t≤t_{ƒ}}. The further constraints may be equality or inequality constraints, such as

$$C 1 : Ku \leq L ,$$

$$C 2 : Mu = N ,$$

where K, L, M, N are constant matrices. In particular, two inequality constraints may be used to limit the control signal u to an acceptable range defined by actuator limits: u≤u(t)≤ū. The cost functional J may refer to the cost of applying a particular control signal to the system, by which energy consumption, energy losses (e.g., thermal dissipation), mechanical wear etc. can be modeled.

In the present disclosure, special attention will be directed to constrained quadratic problems (QP), which may be expressed on the following standard form:

$${min}_{u} \frac{1}{2} {u}^{T} Hu + {f}^{T} u$$

$$s . t . \underline{u} \leq y \leq \overline{u}$$

$$Au \leq b$$

$${A}_{eq} u = {b}_{eq}$$

where H, ƒ, ū, u, A, b, A_{eq}, B_{eq} are matrices and

$$\frac{1}{2} {u}^{T} H u + {f}^{T} u$$

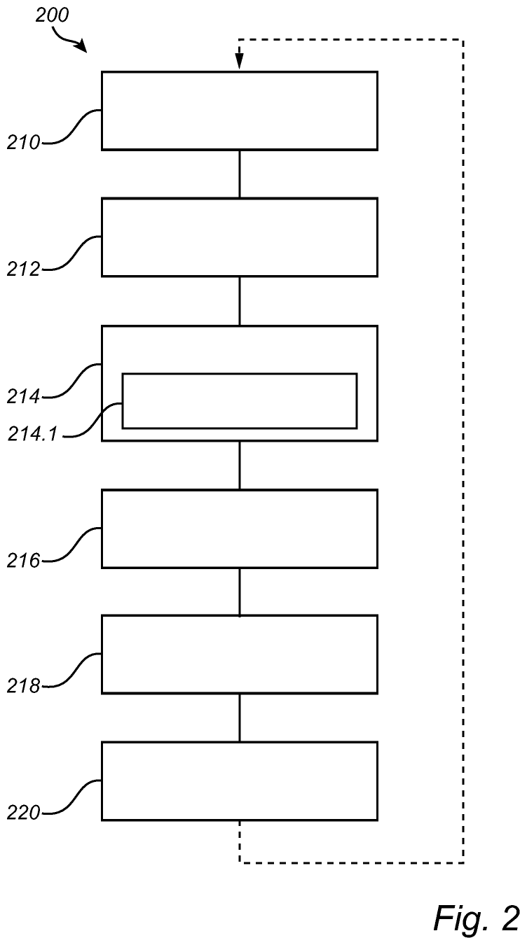

is identified as the cost functional J(u). The matrices may be time-invariant over the solution horizon, or some of the matrices may be allowed to vary. The optional temporal dependence of u has been omitted for clarity. In cases where the technical system 110 is a vehicle system, a problem on this form may be set up on the basis of vehicle parameters like mass, inertia, tire radius, tire cornering stiffness, and desired control targets like desired longitudinal and lateral forces, target service brake power and target powertrain power. The QP problem may represent a linearization of a nonlinear vehicle model which is valid at a working point corresponding to a current state of the vehicle. The cost functional may represent energy losses to be minimized, and some of the constraints could be actuator limits. One example of a control problem is the vehicle motion control for actuator coordination. In some embodiments, the technical system 110 is a propulsion system 310 of a road vehicle 300 (see FIG. 3). The propulsion system 310 may include electric motors for accelerating and decelerating the vehicle in a longitudinal direction (with optional power regeneration), friction brakes or other service brakes, path-controlling actuators (e.g., steering), stabilizers, transmission, suspension details and the like.

To implement these or similar operations, the controller may comprise memory 121, processing circuitry 123 and signal interfaces 122, 125. The processing circuitry 123 is configured to execute one or more optimization processes, which may be of same or different types. The memory 121 may be suitable for storing an executable computer program 124 and optionally configuration data, historic data and other information.

FIG. 1B shows, in functional form, the inner workings of the controller 120 according to one embodiment. The blocks 126, 127, 128, 129 which are visible in FIG. 1B may correspond to physical components or to sections of software code executing on the processing circuitry 123. The connection lines annotated by symbols q, r, S*, u, u*, u** denote information flows occurring at runtime between the blocks 126, 127, 128, 129 and between the controller 120 and the technical system 110.

Block 126 in FIG. 1B represents an optimization process suitable for solving a constrained QP. Block 127 represents an optimization process suitable for solving an unconstrained QP. The connection line therebetween conveys the active set S*, which constitutes information to be used for transforming the constrained QP into an associated unconstrained QP. Once the associated unconstrained QP has been formed, however, the two optimization processes 126, 127 are independent from one another in the sense that each is autarch and/or each is configured to complete the solving process without exchanging solution-related information with the other. Since the active set S* is normally not known until the constrained QP has been solved, the two optimization processes 126, 127 typically execute sequentially in time. For this reason, the optimization processes 126, 127 can in some embodiments be implemented on a shared processing resource without detriment to their independence from each other.

FIG. 1B further shows a block 128, which is configured to compute the quality indicator q on the basis of the outputs of the two optimization processes 126, 127. Also visible in FIG. 1B is a module 129 configured to generate a control signal u for the technical system on the basis of an output of the first optimization process 126. The operation of the module 129 is adaptive with respect to the quality indicator q. In some embodiments, for example, the module 129 may implement a decision whether to utilize the first solution vector u* for generating the control signal u or to apply a safety-oriented fallback control signal, wherein the decision is guided by the quality indicator q. In some embodiments, the module 129 may be configured to decide, still on the basis of the quality indicator q, whether to utilize the first solution vector u*, the second solution vector u** or to rely on the safety-oriented fallback control signal.

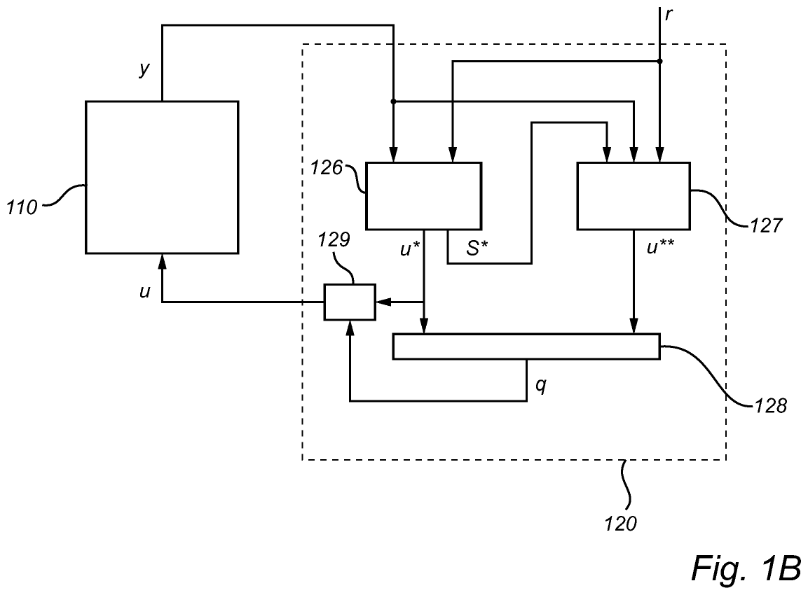

FIG. 2 is a flowchart of a method 200 for controlling in real time a technical system, such as the generic technical system 110 (FIG. 1A) or the vehicle propulsion system 310 (FIG. 3). The method 200 may be implemented in controllers 120 of the types illustrated in FIGS. 1A and 1B, e.g., by providing suitable software 124. If the technical system to be controlled is a system in a vehicle, the controller 120 may be installed in the same vehicle or outside the vehicle while in wireless communication with this. Also envisioned are hybrid configurations where vehicle-mounted principal components of the controller 120 are configured to offload demanding calculations to networked (or cloud) processing resources outside the vehicle, with which the components communicate through a wireless communication network, such as a cellular or non-cellular wide-area network. For example, the optimization processes 126, 127 may be cloud resources, for which both the initialization data and the output data are limited in size, in the sense that the initialization data and the output data can be transmitted over the wireless communication network at runtime without inconvenience. This relieves the controller's 120 vehicle-mounted components of a substantial share of the computational effort needed to control the technical system 110 in the vehicle.

In a first step 210 of the method 200, an execution of an AS optimization process 126 configured to solve a constrained QP is initiated. The AS optimization process 126 may be an iterative numerical solver. Specialized AS methods are particularly fast in some cases, like in problems with rather few constraints. Such a method calculates the active set, i.e., the inequality constraints that are active (i.e., reach equality, saturate) at the optimal solution. Efficient implementations avoid computing inverse matrices for each iteration of the solver but are instead iteratively updated. Reference is made to D. Goldfarb and A. Idnani, “A numerically stable dual method for solving strictly convex quadratic programs”, Mathematical Programming, vol. 27 (1983), pages 1-33, in which an efficient and numerically stable dual algorithm for positive definite QP is described.

The constrained QP, to be solved over d₁-dimensional solution space U with d₁≥1, may be formulated as follows:

$${min}_{u ∈ U} J ( u )$$

$$s . t . \underline{u} \leq u \leq \overline{u}$$

$$Au \leq b$$

Without loss of generality, it is assumed that the equality constraint A_{eq}u=b_{eq} appearing in the above standard form of the QP has been absorbed by the cost functional J(u), e.g., by initially replacing the expression cost function J(u) in the QP by its restriction to the set W={u:A_{eq}u=b_{eq}}:

J(u)|u∈W

The set W may be understood to be a subspace with codimension equal to the number of rows in A_{eq}.

In a second step 212, a first solution vector u* and an associated active set of constraints S* from the execution of the AS optimization process 126 are obtained. The first solution vector u* may be extracted from the AS optimization process 126 after a predetermined delay, wherein the delay may have been set in view of a real-time constraint on the control of the technical system.

It is recalled that, within the matrix inequality Au≤b, an inequality constraint aᵢu≤bᵢ is active if the concerned ith component of the solution vector u* fulfils aᵢuᵢ*=bᵢ, where aᵢ is the ith row vector of A and bᵢ is the ith component of b. Assuming u has d₁=dim U components and b has d₂ components (accordingly, A is a d₂×d₁ matrix), there is a maximum of d₁+d₂ active constraints. (In the special case where some components are equal between u and ū, these components of the solution u will be forced to a particular value. Because this special case can be treated by simpler and per se known methods, it is ignored here.) The active set of constraints S* may be represented as a trinary list of length d₁ and a Boolean list of length d₂. The ith element of the trinary list indicates whether, for the ith component of u, the lower constraint (uᵢ≤ . . . ) or the upper constraint ( . . . ≤ūᵢ), or neither of these, is active. The ith element of the Boolean list indicates whether the ith line of the system of inequations Au≤b represents an active constraint. Alternatively, the constraints are rewritten as

u≤u

u≤ū

Au≤b

and the active set of constraints S* is represented as a binary list of length 2d₁+d₂. The number of active constraints will be denoted |S*| in the present disclosure.

A third step 214 of the method 200 is a variable substitution in accordance with the active set of constraints S*. Let U_{AS} be a subspace of U with codimension |S*| which is such that all active constraints are fulfilled. Then, an invertible variable transformation T:U_{AS}→V, where dim V=d₁−|S*|, can be defined such that u=T(v). The variable transformation is obtained by solving the active inequality constraints, in the case of equality, for |S*| variables. The unconstrained QP is a minimization of the cost functional restricted to V. Introducing the notation J₀(v)=J(u)|_{u=T(v)} for this restriction, the unconstrained QP can be written:

$${min}_{v ∈ V} {J}_{0} ( v ) .$$

### Concretely, if

$$J ( u ) = \frac{1}{2} {u}^{T} H u + {f}^{T} u ,$$

$$then$$

$${J}_{0} ( v ) = \frac{1}{2} {v}^{T} {H}_{0} v + {f}_{0}^{T} v ,$$

where H₀ is a (d₁−|S*|)×(d₁−|S*|) matrix and ƒ₀ is a vector of length d₁−|S*|. In the unconstrained QP, no constraint is imposed other than the constraints that are implicit in the variable substitution u=T(v).

To illustrate, consider the simple case where the AS contains only one inequality constraint aᵢuᵢ≤bᵢ in the ith component. The variable substitution is equivalent to inserting

$$u = [ \begin{matrix}{u}_{1} \\ ⋮ \\ {u}_{i - 1} \\ {u}_{i} \\ {u}_{i + 1} \\ ⋮ \\ {u}_{{d}_{1}}\end{matrix} ] = [ \begin{matrix}{v}_{i} \\ ⋮ \\ {v}_{i - 1} \\ {a}_{i}^{- 1} {b}_{i} \\ {v}_{i} \\ ⋮ \\ {v}_{{d}_{1} - 1}\end{matrix} ] = T ( v )$$

in the cost functional J(u), which is then identified as J₀(v), a function of d₁−1 variables. Accordingly, the unconstrained QP will have a mere d₁−1 variables. In other words, the substituting 214 may include solving 214.1 for one or more of the variables of an inequality constraint in the case of equality. In a general case, the presence of |S*| active constraints provides for variable substitutions that reduce the dimensionality of the QP from d₁ to d₁−|S*|. This is to say, the unconstrained QP is to be solved in a subspace V of the original solution space U, wherein the subspace V has codimension |S*|.

In a fourth step 216 of the method 200, an execution of a second optimization process 127, which is configured to solve the associated unconstrained QP, is initiated. The second optimization process 127 may be of the same type as the first optimization process 126, or of a different type. For example, the second optimization process 127 may be an iterative numerical solver or, in simple cases, a direct solution formula. Specific examples include an interior-point method (IP), alternating direction method of multipliers (ADMM), successive linear programming (SLP), sequential quadratic programming (SQP), sequential linear-quadratic programming (SLQP), a reduced-gradient (RG) method.

From the execution of the second optimization process 127, in a fifth step 218, a second solution vector u** is obtained. The second solution vector u** may be extracted from second optimization process 127 after a predetermined delay.

This provides the necessary information to generate, in a sixth step 220 of the method 200, a quality indicator q for the first solution vector u* on the basis of a difference between the first and second solution vectors. The difference may be proportional to a norm of the vector difference ∥u*−u**∥, wherein the norm may be an L^{p} or l^{p} norm with p≥1. Of particular interest are differences based on the Euclidean norm (p=2) and the maximum norm (p=∞).

The calculation of the difference may include an initial substep of undoing the variable substitution. Letting v**∈V denote the second solution vector as it was obtained directly from the second optimization process 127, the calculation of the difference may include an initial substep of transforming v** back to the subspace U_{AS} by the mapping

$${u}^{* *} = {T}^{- 1} ( {v}^{* *} ) ,$$

whereby the variable substitution is undone. It is recalled that T is invertible as a mapping from U_{AS} to V. The vector u** obtained in this manner has length d₁, so that the difference u*−u** is well-defined.

Another imaginable preparatory step before the difference ∥u*−u**∥ is computed is to normalize the first and second solution vectors u*, u** relative to each other, to be mutually comparable. Indeed, the substitutions

$${u}^{*} ↦ \frac{{u}^{*} - {μ}_{i}^{*}}{\sqrt{{σ}_{i}^{*}}} , {u}^{* *} ↦ \frac{{u}^{* *} - {μ}_{i}^{* *}}{\sqrt{{σ}_{i}^{* *}}}$$

where μᵢ*, μᵢ** are the respective means and σᵢ*, σᵢ** are the respective variances of the obtained solution vectors, will ensure that the rescaled solution vectors on the left-hand side have zero mean and unit variance. Alternatively, σᵢ* (σᵢ**) may be a vector of component-wise variances and the division operation is a component-wise operation; this will ensure that each component of the rescaled solution vector has zero mean and unit variance.

With continued reference to the sixth step 220 of the method 200, the quality indicator q may be generated, alternatively or additionally, on the basis of the respective costs of the first and second solution vectors J(u*),J(u**). For example, the quality indicator q may include a term |J(u*)−J(u**)|. Here, by construction, J(u**)=J₀(v**), where v** denotes the second solution vector as it was obtained directly from the second optimization process 127. In different embodiments of the method 200, the quality indicator depends only on the vector-difference term ∥u*−u**∥, only on the cost-difference term |J(u*)−J(u**)| or on a weighted linear combination of both terms. Defined in any of these ways, the quality indicator will approach zero when the first solution vector u* resembles the second vector u** most faithfully. For reasons to be discussed below, this may be understood to mean that the first solution vector u* has relatively high quality and may be considered to be relatively reliable.

In an optional seventh step of the method 200, the generated quality indicator q is used to decide whether or not to utilize the first solution vector u* for generating a control signal u to the technical system. The decision-making can be implemented in the block 129 (see FIG. 1B) of the controller 120.

For illustration purposes, the method 200 will be recapitulated for the following example constrained QP:

$${min}_{u ∈ U} J ( u )$$

$$s . t . \underline{u} \leq u \leq \overline{u}$$

$$where J ( u ) = \frac{1}{2} {u}^{T} H u + {f}^{T} u with$$

$$u = [ \begin{matrix}{u}_{1} \\ {u}_{2} \\ {u}_{3}\end{matrix} ] , H = [ \begin{matrix}{h}_{11} & {h}_{12} & {h}_{13} \\ {h}_{12} & {h}_{22} & {h}_{23} \\ {h}_{13} & {h}_{23} & {h}_{33}\end{matrix} ] , f = [ \begin{matrix}{f}_{1} \\ {f}_{2} \\ {f}_{3}\end{matrix} ] , \overline{u} = [ \begin{matrix}{\overline{u}}_{1} \\ {\overline{u}}_{2} \\ {\overline{u}}_{3}\end{matrix} ] , \underline{u} = [ \begin{matrix}{\underline{u}}_{1} \\ {\underline{u}}_{2} \\ {\underline{u}}_{3}\end{matrix} ] .$$

It is assumed that solving the constrained QP provides a first solution vector u* and that the active set S* contains the sole constraint u₂=ū₂. The associated unconstrained QP is formed by substituting u₂=ū₂ in J(u) and discarding all inactive constraints, to obtain:

$${min}_{v ∈ V} {J}_{0} ( v ) ,$$

$$where J ( v ) = \frac{1}{2} {v}^{T} {H}_{0} v + {f}_{0}^{T} v with$$

$$v = [ \begin{matrix}{u}_{1} \\ {u}_{3}\end{matrix} ] , {H}_{0} = [ \begin{matrix}{h}_{11} & {h}_{13} \\ {h}_{13} & {h}_{33}\end{matrix} ] , f = [ \begin{matrix}{f}_{1} + {h}_{12} {\overline{u}}_{2} \\ {f}_{3} + {h}_{23} {\overline{u}}_{2}\end{matrix} ] .$$

Solving the associated unconstrained QP yields

$${v}^{* *} = [ \begin{matrix}{v}_{1}^{* *} \\ {v}_{3}^{**}\end{matrix} ] ,$$

which can be expressed as a vector in U by inverting the variable substitution:

$${u}^{* *} = [ \begin{matrix}{v}_{1}^{**} \\ {\overline{u}}_{2} \\ {v}_{3}^{**}\end{matrix} ] .$$

With this data, it is possible to compute the vector difference u*−u** as well as the cost difference J(u*)−J(u**) (or J(u*)−J₀(v**)), whereby the quality indicator q according to different definitions can be evaluated.

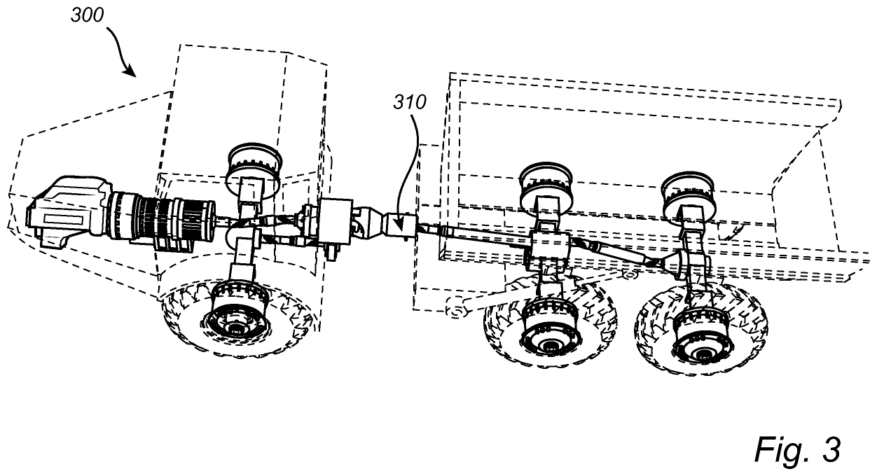

Reference is made to FIG. 4 which plots, as a function of the constrained QP's condition number, the error of an active-set optimization process solving the constrained QP relative to a ground-truth solution of the constrained QP. The ground-truth solutions have been computed without any limitations on time or processing resources. The plot is in logarithmic units. As the dashed trend line suggests, the maximum observed error of the optimization process grows with the condition number of the QP.

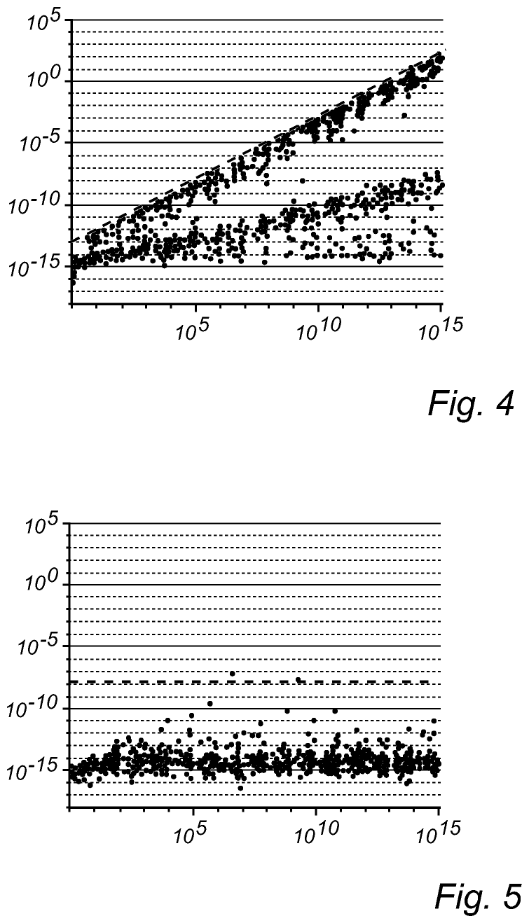

FIG. 5 plots, as a function of the constrained QP's condition number, the error of an optimization process solving the associated unconstrained QP relative to a ground-truth solution of the constrained QP. Again, the ground-truth solutions have been provided without any limitations on time or processing resources. It is seen that the error is uniformly bounded for all tried condition numbers. This underlines the usefulness of the associated unconstrained QP as a reference in real use cases where evidently no ground-truth solution is available and, generally, the condition number is unknown. More precisely, a solution u** of the associated unconstrained QP can be utilized for the purpose of determining whether the first solution vector u* is a reliable solution of the constrained QP.

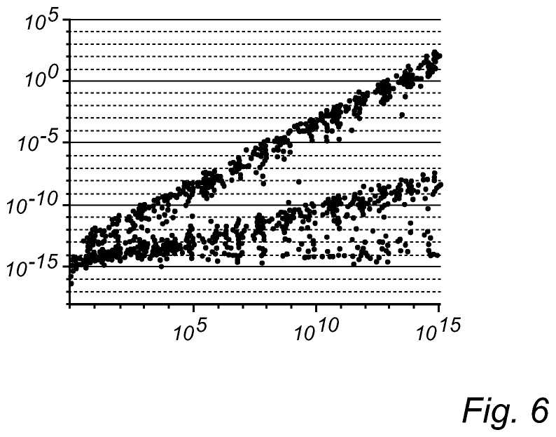

FIG. 6 is a plot of the difference ∥u*−u**∥ between the first and second solution vectors for a constrained QP modelling a propulsion system in a road vehicle. As expected, the maximum error grows with the condition number but similarly to the pattern seen in FIG. 4. This attests to the applicability of the proposed quality assessment method 200 to the particular use case of vehicle propulsion control.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A computer-implemented method for assessing the quality of a solution from an optimization process configured to solve a constrained quadratic problem (QP) the method comprising:
initiating an execution of an active-set (AS) optimization process configured to solve the constrained QP;
obtaining a first solution vector and an associated active set of constraints from the execution of the AS optimization process;
substituting variables in the constrained QP in accordance with the active set of constraints to form an associated unconstrained QP, wherein the variable substitution reduces the dimensionality by the number of constraints in the active set;
initiating an execution of a second optimization process configured to solve the associated unconstrained QP;
obtaining a second solution vector from the execution of the second optimization process, including undoing the variable substitution; and
generating a quality indicator for the first solution vector on the basis of a difference between the first and the second solution vectors.

2. The method of claim 1, wherein the difference is related to a vector difference of the first and the second solution vectors.

3. The method of claim 1, wherein:
the predefined constrained QP includes an optimization of a cost functional; and
the quality indicator is generated further on the basis of the respective costs of the first and the second solution vectors.

4. The method of claim 1, wherein the substitution of variables includes solving for one of the variables of an inequality constraint in the case of equality.

5. The method of claim 1, wherein the AS optimization process and/or the second optimization process is iterative.

6. The method of claim 5, wherein the first solution vector and/or the second solution vector is extracted after a predetermined delay.

7. The method of claim 1, wherein the AS optimization process and the second optimization process are of different types.

8. The method of claim 1, wherein the AS optimization process includes executing one or more selected from the set comprising:
an interior-point method (IP); alternating direction method of multipliers, (ADMM); successive linear programming (SLP); sequential quadratic programming (SQP); sequential linear-quadratic programming (SLQP); a reduced gradient method (RG).

9. The method of claim 1, wherein the constrained QP relates to control of a technical system, further comprising:
deciding, on the basis of the quality indicator, whether or not to utilize the first solution vector for generating a control signal to the technical system.

10. The method of claim 9, wherein the constrained QP relates to control of a technical system in real time.

11. The method of claim 9, wherein the technical system is an over-actuated technical system, such as a propulsion system in a road vehicle.

12. A controller configured to control a technical system in real time, the controller comprising memory, a signal interface, and processing circuitry configured to perform the method of claim 1.

13. A computer program comprising instructions for causing a controller configured to control a technical system in real time, the controller comprising memory, a signal interface, and processing circuitry, to perform the method of claim 1.
